(19) United States
(12) Patent Application Publication
(10) Pub. No.: US 2024/0184943 A1
(43) Pub. Date: Jun. 6, 2024

(54) CABLE MODELING METHOD AND SYSTEM, AND ELECTRONIC DEVICE

(71) Applicant: Beijing Urban Construction Design & Development Group Co., Limited., Beijing (CN)

(72) Inventors: Guangliang Zheng, Beijing (CN); Bo Li, Beijing (CN); Dezhi Han, Beijing (CN); Fucai Hua, Beijing (CN); Liangyin Yang, Beijing (CN); Gang Wang, Beijing (CN); Shunxing Wang, Beijing (CN); Hongyun Zou, Beijing (CN); Lanmu Zeng, Beijing (CN); Du Yang, Beijing (CN); Jianjun Zhang, Beijing (CN); Wei Liu, Beijing (CN); Xin Shao, Beijing (CN); Yuan Kong, Beijing (CN); Xiao Wang, Beijing (CN)

(21) Appl. No.: 18/454,080

(22) Filed: Aug. 23, 2023

(30) Foreign Application Priority Data
Dec. 6, 2022 (CN) 2022115557188

(51) Int. Cl. G06F 30/18; G06F 30/17

(52) U.S. Cl. CPC G06F 30/18; G06F 30/17; G06F 2113/16

(57) ABSTRACT

A cable modeling method and system, and an electronic device are provided. The method includes: acquiring preset cable attributes of a cable and a preset laying scenario of the cable; determining a start point, an end point and a path point of the cable according to the preset laying scenario; inputting the preset attributes of the cable, the start point, the end point, and the path point into an Autodesk Revit software to model the cable, thereby to obtain a cable simulation model; and laying the cable according to the cable simulation model. The method first determines a start point, an end point, and the path point of the cable through the preset laying scenario, and then inputs the preset attributes, the start point, the end point, and the path point into the Autodesk Revit software to model the cable, so as to obtain a cable simulation model.

### TECHNICAL FIELD

The disclosure relates to the technical field of cable modeling, particularly to a cable modeling method and system, and an electronic device.

### BACKGROUND

Building information modeling (BIM) technology provides functions of design, drawing and quantity calculation required by building constructions. The BIM technology can meet design requirements of different disciplines such as architecture, structure and equipment, provide different solutions for different disciplines, help designers design, build and maintain buildings with better quality and higher energy efficiency, and is widely used in civil buildings, water conservancy and hydropower, rail transit and other fields. However, original functions of the Revit modeling software (i.e., Autodesk Revit software which is a type of BIM software) cannot meet all engineering characteristics. The Revit modeling software has poor support for functional requirements of linear engineering, especially for cable models in linear engineering, there is no corresponding model creation function. To promote the deep integration of BIM technology and professional design methods, it is urgent to develop a method for simulating cable sag in three-dimensional space based on the commonly used Revit modeling software of the BIM technology in the market.

There are two main implementation methods for cable modeling based on Revit in the industry:

The first method is to design and model cables through model lines or conduits, but the model lines and conduits do not support sag simulation of overhead cables. Not only does the appearance of the model deviate significantly from the actual situation, but it also affects the accuracy of engineering quantity statistics.

The second method is to generate cable appearance by using a Dynamo software, calling application programming interfaces (API) of Revit, or secondary development of Revit software, and importing the cable appearance into the project model in the form of loadable family. This method can simulate overhead cable sag, but the disadvantage is that after the loadable family is imported into the project model, the generated cable model cannot be edited to adjust a cable type and a cable diameter. The discipline, system, cable type, and quantities are all written by the program at one time. Component update linkage is not supported and the model volume is too large.

### SUMMARY

In order to overcome shortcomings in the related art, a purpose of the disclosure is to provide a cable modeling method, system, and electronic device thereof.

A cable modeling method, including:

step 1: acquiring preset attributes of a cable and a preset laying scenario of the cable;

step 2: determining a start point, an end point and a path point of the cable according to the preset laying scenario;

step 3: inputting the preset attributes of the cable, the start point, the end point, and the path point into an Autodesk Revit software to model the cable, thereby to obtain a cable simulation model; and

step 4: laying the cable according to the cable simulation model.

In an embodiment, the step 2 includes:

step 2.1: determining a sag of the cable according to suspension points of the cable and a span length of the cable;

step 2.2: determining a three-dimensional spatial curve of the cable according to the sag of the cable; and

step 2.3: obtaining the start point, the end point, and the path point of the cable by performing discrete calculations on the three-dimensional spatial curve.

In an embodiment, in the step 2.1, the determining a sag of the cable according to suspension points of the cable and a span length of the cable further includes:

in a situation that the cable is overhead outdoors and h/l≤0.1, determining the sag of the outdoor overhead cable using a formula

$$f = \frac{{gl}^{2}}{8 {σ}_{0}} ,$$

where f represents the sag of the outdoor overhead cable, g represents a specific load of the outdoor overhead cable, h represents a height difference between the suspension points, l represents the span length, and σ₀ represents a horizontal stress at a lowest point of the outdoor overhead cable.

In an embodiment, in the step 2.1, the determining a sag of the cable according to suspension points of the cable and a span length of the cable further includes:

in a situation that the cable is overhead outdoors and 0.1<h/l≤0.25, determining the sag of the outdoor overhead cable using a formula

$$f = \frac{{gl}^{2}}{8 {σ}_{0} cos β} ,$$

where f represents the sag of the outdoor overhead cable, g represents a specific load of the outdoor overhead cable, h represents a height difference between the suspension points, l represents the span length, σ₀ represents a horizontal stress at a lowest point of the outdoor overhead cable, β represents a height difference angle of the suspension point when the suspension points are not equal in height, and

$$β = {tan}^{- 1} \frac{h}{l} .$$

In an embodiment, in the step 2.1, the determining a sag of the cable according to suspension points of the cable and a span length of the cable further includes:

in a situation that the cable is overhead outdoors and 1<l<2, determining the sag of the outdoor overhead cable using a formula

$${f}_{x} = \frac{g}{2 {σ}_{0}} {l}_{a} {l}_{b} ,$$

where l represents the span length, fₓ represents a sag of a point on the outdoor overhead cable, g represents a specific load of the outdoor overhead cable, σ represents a horizontal stress at a lowest point of the outdoor overhead cable, lₐ represents a horizontal distance from a suspension point A to the point on the outdoor overhead cable, and l_{b} represents a horizontal distance from a suspension point B to the point on the outdoor overhead cable.

In an embodiment, in the step 2.1, the determining a sag of the cable according to suspension points of the cable and a span length of the cable further includes:

in a situation that the cable is overhead indoors, determining the sag of the indoor overhead cable using a formula

$$y = ach \frac{x}{a} = \frac{a}{2} ( {e}^{\frac{x}{a}} + {e}^{\frac{x}{a}} ) ,$$

where y represents the sag of the indoor overhead cable, h represents a height difference between the suspension points, a represent a constant, and ch represents a hyperbolic cosine function.

The disclosure further provides a cable laying system, and the cable laying system includes:

a cable parameter acquisition module, configured to acquire preset attributes of a cable and a preset laying scenario;

a cable laying determination module, configured to determine a start point, an end point and a path point of the cable according to the preset laying scenario;

a cable simulation module, configured to input the preset attributes of the cable, the start point, the end point, and the path point into an Autodesk Revit software to model the cable, thereby to obtain a cable simulation model; and

a cable laying module, configured to lay the cable according to the cable simulation model.

The disclosure further provides an electronic device, and the electronic device includes a bus, a transceiver, a memory, a processor, and a computer program stored on the memory. The computer program is configured to be executed on the processor; the transceiver, the memory, and the processor are connected through the bus. When the computer program is executed through the processor, the steps in the cable modeling method are implemented.

The disclosure further provides a nonvolatile computer-readable storage medium, a computer program is stored in the nonvolatile computer-readable storage medium, and the steps in the cable modeling method are implemented when the computer program is executed by a processor.

The cable modeling method and system, and an electronic device provided by the disclosure have the following beneficial effects: compared with the related art, the disclosure first determines a start point, an end point, and a path point of the cable through a preset laying scenario, and then input the preset attributes of the cable, the start point, the end point, and the path point into the Autodesk Revit software to model the cable and obtain a cable simulation model (also referred to as a cable model). The cable model can be established quickly and accurately based on a specific application scenario.

In order to understand the above purpose, features, and advantages of the disclosure clearer, the following will provide some exemplary embodiments, and a detailed explanation of the exemplary embodiments is as follows in conjunction with the attached drawings.

### BRIEF DESCRIPTION OF DRAWINGS

In order to provide a clearer description of embodiments of the disclosure or the technical solutions in the related art, a brief introduction will be given to the attached drawings required in the description of the embodiments or related art. It is apparent that the attached drawings in the following description are only some embodiments of the disclosure. For ordinary those skilled in the art, other attached drawings can be obtained based on these attached drawings without any creative work.

FIG. 1 illustrates a flowchart of a cable modeling method provided in an embodiment of the disclosure.

FIG. 2 illustrates a principle diagram of calculating a sag of a cable provided in the embodiment of the disclosure.

FIG. 3 illustrates a schematic diagram of defining a cable system in the software Revit provided in the embodiment of the disclosure.

FIG. 4 illustrates a schematic diagram of defining a cable type in the software Revit provided in the embodiment of the disclosure.

FIG. 5 illustrates a schematic diagram of editing and modifying cables in the software Revit provided in the embodiment of the disclosure.

FIG. 6 illustrates a schematic diagram of cable statistics in the software Revit provided in the embodiment of the disclosure.

### DETAILED DESCRIPTION OF EMBODIMENTS

In the description of the disclosure, it should be understood that terms “center”, “longitudinal”, “transverse”, “length”, “width”, “thickness”, “top”, “bottom”, “front”, “back”, “left”, “right”, “vertical”, “horizontal”, “top”. “bottom”, “inside”, “outside”, “clockwise”, “counterclockwise” and the like used to indicate an orientation or positional relationship are based on the orientation or positional relationship shown in the attached drawings. The terms are intended only to facilitate and simplify the description of the disclosure, but not intended to indicate or imply that a device or an element in the disclosure must have a specific orientation, be constructed in the specific orientation, or be operated in the specific orientation. Therefore, the terms should not be considered as a limitation of the disclosure.

In addition, terms “first”, “second” and the like are only used to facilitate a description and cannot be understood as indicating or implying relative importance or implying a number of technical features. Therefore, features limited with “first” and “second” can explicitly or implicitly include one or more of these features. In the description of the disclosure, unless otherwise specifically defined, “multiple” means two or more.

In the disclosure, unless otherwise specifically defined and limited, terms “installation”, “connection”, “fixation” and others should be broadly understood. For example, “connection” can be a fixed connection, a detachable connection, or an integrated connection; it can be a mechanical connection or an electrical connection; it can be a direct connection, an indirect connection through an intermediate medium, or an internal connection between two components. For ordinary those skilled in the art, the specific meanings of the above terms in the disclosure can be understood according to specific situations.

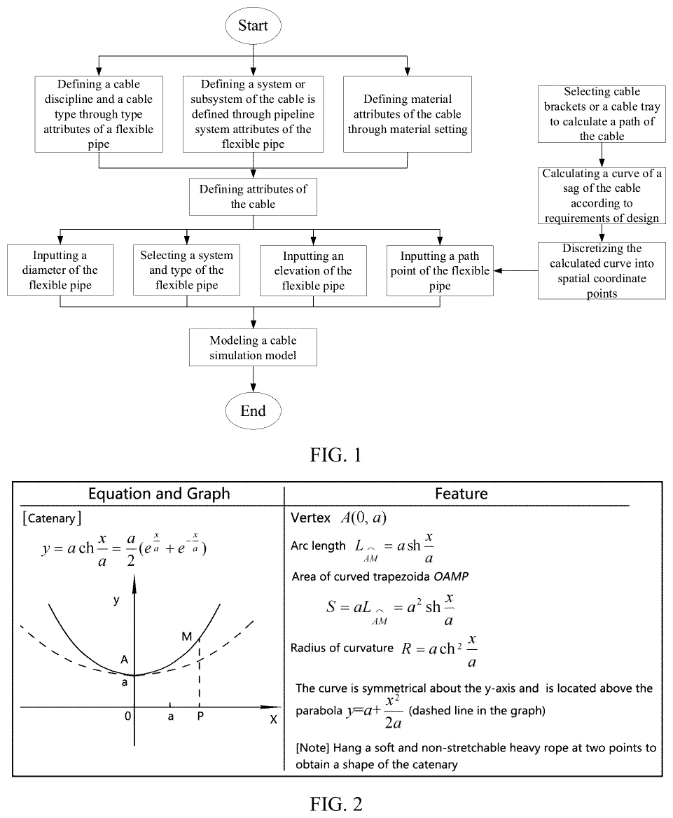

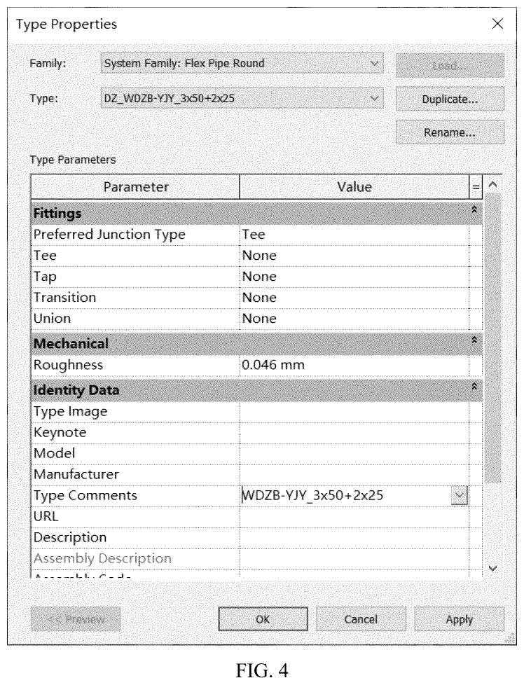

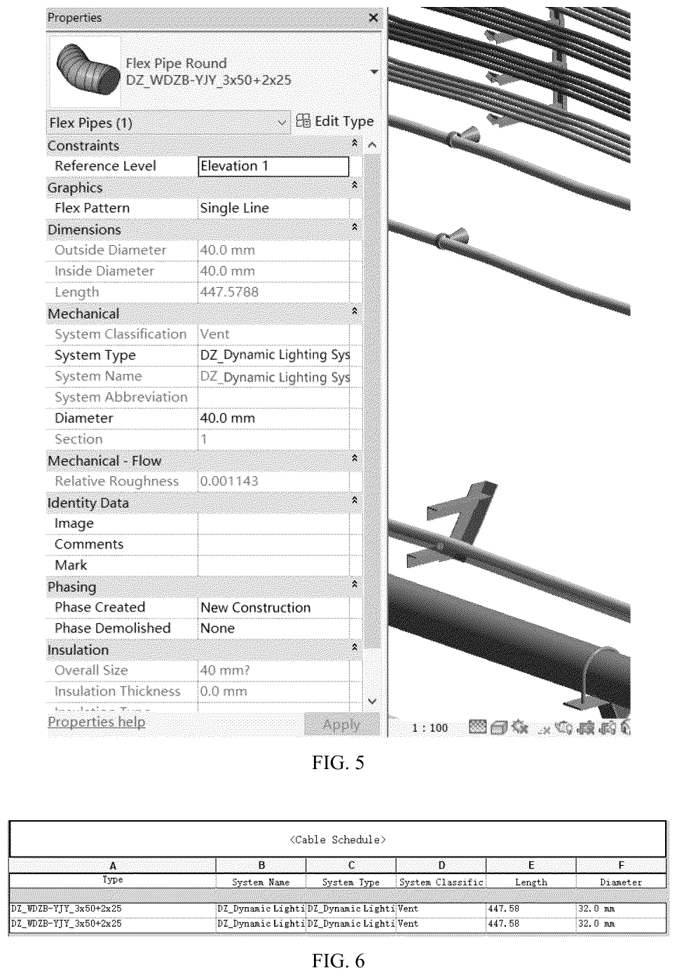

As shown in FIGS. 1-6, a cable modeling method is provided and the cable modeling method is as follows.

Hose is an existing model category in MEP (mechanical, electrical, piping) systems in a Revit software. This category has main attributes such as connectors, diameter, length, material, type, elevation, offset value, piping system, start point, end point, vertices, etc. Main parameters for creating the hose include pipeline system, hose type, elevation, feature points, and so on.

The disclosure models a cable through using a native hose system family of the Revit software, and the cable can be connected through the setting of hose connectors in the Revit software. A cable diameter can be defined through setting a diameter of the hose in the software. The length attribute of the hose can provide good statistics on the engineering quantity of the cable. A cable type can be defined through the type attribute of the hose. A height of the cable in space is positioned through the elevation and offset value attributes of the hose. A system or subsystem of the cable is defined through pipeline system attributes of the hose (i.e., a hose modeling method in the existing software is used to replace a cable modeling process). However, the existing software Revit cannot automatically complete an entire cable modeling process based on actual scenarios. In the disclosure, after parameters of the cable are calculated, the hose can be created through using a function named “FlexPipe. Create Method” in the RevitAPI to complete the cable modeling.

Step 1: acquiring preset attributes of a cable and a preset laying scenario of the cable.

Step 2: determining a start point, an end point and a path point of the cable according to the preset laying scenario.

Furthermore, the step 2 includes step 2.1, and the step 2.1 includes: determining a sag of the cable according to suspension points of the cable and a span length of the cable (i.e., a distance between two suspension points).

A size of a sag of an outdoor overhead cable (i.e., a cable is overhead outdoors) is related to factors such as span, specific load of the cable, and stress. When an overhead cable is designed, the cable sag is generally minimized within an allowable range of a mechanical strength of the cable. In order to maximize the utilization of the mechanical strength of the cable, reduce heights of towers, reduce economic cost, and achieve a safe operation. Calculations for the cable sag include four points.

1) When a height difference between suspension points does not exist or is small (in other words, h/l≤0.1), a sag of an outdoor overhead cable is calculated by a formula

$$f = \frac{{gl}^{2}}{8 {σ}_{0}} ;$$

where f represents the sag of the outdoor overhead cable, g represents a specific load of the outdoor overhead cable, h represents a height difference between the suspension points, l represents the span length, and σ₀ represents a horizontal stress at a lowest point of the outdoor overhead cable.

2) When a height difference between suspension points is large (in other words, 0.1<h/l≤0.25), a sag of an outdoor overhead cable is calculated by a formula

$$f = \frac{{gl}^{2}}{8 {σ}_{0} cos β} ;$$

where f represents the sag of the outdoor overhead cable, g represents a specific load of the outdoor overhead cable, h represents a height difference between the suspension points, l represents the span length, σ₀ represents a horizontal stress at a lowest point of the outdoor overhead cable, β represents a height difference angle when suspension points are not equal in height (i.e., there is a height difference between suspension points), and

$$β = {tan}^{- 1} \frac{h}{l} .$$

3) When 1<l<2, a sag of a point on an outdoor overhead cable is calculated by a formula

$${f}_{x} = \frac{g}{2 {σ}_{0}} {l}_{a} {l}_{b} ;$$

where l represents a span length, fₓ represents the cable sag of the point on the outdoor overhead cable, g represents a specific load of the outdoor overhead cable, σ₀ represents a horizontal stress at a lowest point of the outdoor overhead cable, lₐ represents a horizontal distance from a suspension point A to the point on the outdoor overhead cable, and l_{b} represents a horizontal distance from a suspension point B to the point on the outdoor overhead cable.

4) An indoor cable is usually installed in a cable tray or fixed by cable brackets. When a cable is installed in the cable tray, a calculation for the cable sag is not considered. When the cable is fixed with a bracket, the indoor cable does not consider a calculation for cable stress. According to the commonly used 5% to 10% cable allowance in engineering, the cable sag is calculated based on the engineering quantity data, and the cable allowance can be customized. Please refer to FIG. 2, in an embodiment of the disclosure, a following formula can be used:

$$y = ach \frac{x}{a} = \frac{a}{2} ( {e}^{\frac{x}{a}} + {e}^{\frac{x}{a}} )$$

where, y represents a sag of the indoor cable, h represents a height difference between the suspension points, a represent a constant. A principle of the formula refers to FIG. 2, and sh and ch in FIG. 2 represent a hyperbolic sine function and a hyperbolic cosine function respectively.

Step 2.2: determining a three-dimensional spatial curve of the cable according to the sag of the cable.

Step 2.3: obtaining the start point, the end point, and the path point of the cable by performing discrete calculations on the three-dimensional spatial curve.

Step 3: inputting the preset attributes of the cable, the start point, the end point, and the path point into an Autodesk Revit software to model the cable, thereby to obtain a cable simulation model.

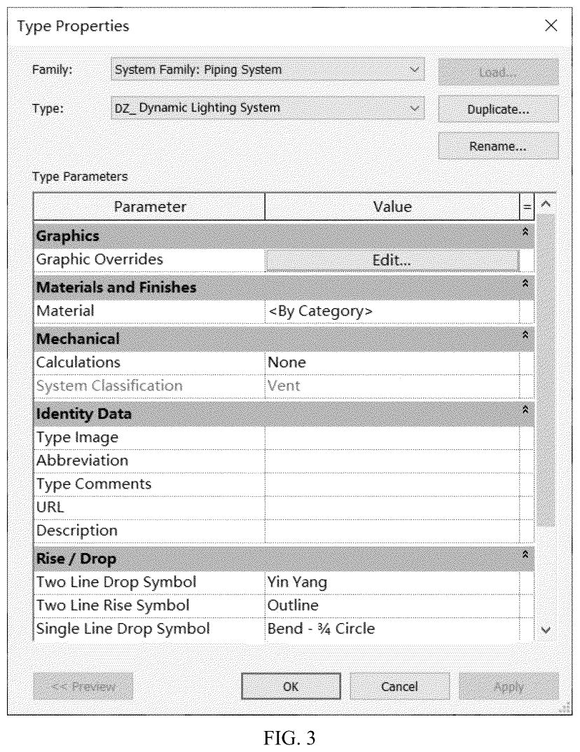

Furthermore, please refer to FIGS. 3-6. After the preset attributes of the cable are defined, a cable model can be quickly created through the hose category. After parameters including hose type, pipeline system, elevation, offset value, diameter, start and end points, vertices and so on are inputted in the software, the creation of the cable mode can be completed.

Some source codes related to the creation of the cable model are as follows:

```
  using(Transactiontr=newTransaction(m_doc,“CreateFlexPipe”))
    {
      tr.Start( );
      FlexPipeflexPipe=FlexPipe.Create(m_doc,m_systemTypeId,m_pi
peTypeId,m_levelId,m_points[1]-m_points[0],m_points[m_points.Count-1]-
m_points[m_points.Count-2],m_points);
      Parameterparameter=flexPipe.get_Parameter(BuiltInParameter.R
BS_PIPE_DIAMETER_PARAM);
      parameter.SetValueString(form.m_diameter);
      List<double>weightList=newList<double>( );
      for(inti=0;i<pointList.Count;i++)
      {
        weightList.Add(1.0);
      }
      doublelength;
      using(Curvecurve=RevitExtension.CreateCurve(pointList,weight
List))
      {
        length=curve.Length;
      }
      if(tr.Commit( )==TransactionStatus.Committed)
      {
        if(PublicFun.SendStatistical(length))
        {
          MessageBox.Show(“Arrangement completed”);
        }
      }
    }
```

Step 4: laying the cable according to the cable simulation model.

According to the embodiment of the disclosure, the disclosure has following four beneficial effects.

(1) The disclosure perfectly integrates the system type, subsystem type, diameter, length, and connection characteristics of cable attributes and building information modeling (BIM) model attributes, without the need for redefinition. It optimizes the algorithm path of BIM technology and avoids wasting additional computing power.

(2) The cable simulation method of the disclosure has good support for curves and supports simulation of cable bending and sagging.

(3) Unlike the one-time information writing method for loadable families created through traditional secondary development, after the model is created, it still supports modifications to cable specialties, systems, subsystems, diameters, routing, and connections in the BIM environment. The engineering quantity also varies with the length of the cable, greatly improving flexibility.

(4) The cable modeling of the disclosure uses a system family to complete the cable model, which reduces the model volume by more than 60% with the same accuracy compared to a loadable family modeling method.

The disclosure further provides a cable laying system, and the cable laying system includes:

a cable parameter acquisition module, configured to acquire preset attributes of a cable and a preset laying scenario;

a cable laying determination module, configured to determine a start point, an end point and a path point of the cable according to the preset laying scenario;

a cable simulation module, configured to input the preset attributes of the cable, the start point, the end point, and the path point into an Autodesk Revit software to model the cable, thereby to obtain a cable simulation model; and

a cable laying module, configured to lay the cable according to the cable simulation model.

The disclosure further provides an electronic device, and the electronic device includes a bus, a transceiver, a memory, a processor, and a computer program stored on the memory. The computer program is configured to be executed on the processor; the transceiver, the memory, and the processor are connected through the bus. When the computer program is executed through the processor, the steps in the cable modeling method are implemented. Compared with the related art, the beneficial effects of the electronic device provided by the disclosure are the same as those of the cable modeling method described in the above technical solution, and will not be repeated here.

The disclosure further provides a nonvolatile computer-readable storage medium, a computer program is stored in the nonvolatile computer-readable storage medium, and the steps in the cable modeling method are implemented when the computer program is executed by a processor. Compared with the related art, the beneficial effects of the electronic device provided by the disclosure are the same as those of the computer-readable storage medium described in the above technical solution, and will not be repeated here.

The above is only a specific embodiment of the disclosure, but the scope of protection of the disclosure is not limited to this. Changes or replacements within the scope of the disclosed technology can be thought by those skilled in the art easily should be covered by the scope of protection of the disclosure. Therefore, the scope of protection of the disclosure should be based on the scope of protection of the claims.

What is claimed is:

1. A cable modeling method, comprising:
step 1: acquiring preset attributes of a cable and a preset laying scenario of the cable;
step 2: determining a start point, an end point and a path point of the cable according to the preset laying scenario;
step 3: inputting the preset attributes of the cable, the start point, the end point, and the path point into an Autodesk Revit software to model the cable, thereby to obtain a cable simulation model; and
step 4: laying the cable according to the cable simulation model.

2. The cable modeling method as claimed in claim 1, wherein in the step 2, the determining a start point, an end point and a path point of the cable according to the preset laying scenario comprises:
step 2.1: determining a sag of the cable according to suspension points of the cable and a span length of the cable;
step 2.2: determining a three-dimensional spatial curve of the cable according to the sag of the cable; and
step 2.3: obtaining the start point, the end point, and the path point of the cable by performing discrete calculations on the three-dimensional spatial curve.

3. The cable modeling method as claimed in claim 2, wherein in the step 2.1, the determining a sag of the cable according to suspension points of the cable and a span length of the cable further comprises:
in a situation that the cable is overhead outdoors and h/l≤0.1, determining the sag of the outdoor overhead cable using a formula f=gl²/8σ₀,
where f represents the sag of the outdoor overhead cable, g represents a specific load of the outdoor overhead cable, h represents a height difference between the suspension points, l represents the span length, and σ₀ represents a horizontal stress at a lowest point of the outdoor overhead cable.

4. The cable modeling method as claimed in claim 2, wherein in the step 2.1, the determining a sag of the cable according to suspension points of the cable and a span length of the cable further comprises:
in a situation that the cable is overhead outdoors and 0.1<h/l≤0.25, determining the sag of the outdoor overhead cable using a formula
$$f = \frac{{gl}^{2}}{8 {σ}_{0} cos β} ,$$
where f represents the sag of the outdoor overhead cable, g represents a specific load of the outdoor overhead cable, h represents a height difference between the suspension points, l represents the span length, σ₀ represents a horizontal stress at a lowest point of the outdoor overhead cable, β represents a height difference angle of the suspension point when the suspension points are not equal in height, and
$$β = {tan}^{- 1} \frac{h}{l} .$$

5. The cable modeling method as claimed in claim 2, wherein in the step 2.1, the determining a sag of the cable according to suspension points of the cable and a span length of the cable further comprises:
in a situation that the cable is overhead outdoors and 1<l<2, determining a sag of the outdoor overhead cable using a formula
$${f}_{x} = \frac{g}{2 {σ}_{0}} {l}_{a} {l}_{b} ,$$
where l represents the span length, fₓ represents a sag of a point on the outdoor overhead cable, g represents a specific load of the outdoor overhead cable, σ₀ represents a horizontal stress at a lowest point of the outdoor overhead cable, lₐ represents a horizontal distance from a suspension point A to the point on the outdoor overhead cable, and l_{b} represents a horizontal distance from a suspension point B to the point on the outdoor overhead cable.

6. The cable modeling method as claimed in claim 2, wherein in the step 2.1, the determining a sag of the cable according to suspension points of the cable and a span length of the cable further comprises:
in a situation that the cable is overhead indoors, determining the sag of the indoor overhead cable using a formula
$$y = ach \frac{x}{a} = \frac{a}{2} ( {e}^{\frac{x}{a}} + {e}^{\frac{x}{a}} ) ,$$
where y represents the cable sag of the indoor overhead cable, a represent a constant, and ch represents a hyperbolic cosine function.

7. An electronic device, comprising: a bus, a transceiver, a memory, a processor, and a computer program stored on the memory;
wherein the computer program is configured to be executed on the processor; the transceiver, the memory, and the processor are connected through the bus; and when the computer program is executed through the processor, the steps in the cable modeling method as claimed in claim 1 are implemented.

8. A nonvolatile computer-readable storage medium, wherein a computer program is stored in the nonvolatile computer-readable storage medium, and the steps in the cable modeling method as claimed in claim 1 are implemented when the computer program is executed by a processor.
